(19) United States
(12) Patent Application Publication
(10) Pub. No.: US 2005/0088593 A1
(43) Pub. Date: Apr. 28, 2005

(54) Liquid crystal display device

(76) Inventor: Naofumi Yamauchi, Chiba-shi (JP)

Correspondence Address: ADAMS & WILKS;31st Floor, 50 Broadway, New York, NY, 10004, US

(21) Appl. No.: 10/958,083

(22) Filed: Oct. 4, 2004

(30) Foreign Application Priority Data
Oct. 17, 2003 (JP) 2003-357258
Dec. 26, 2003 (JP) 2003-434386
Sep. 15, 2004 (JP) 2004-268919

(51) Int. Cl. G02F 1/1335

(52) U.S. Cl. 349/114

(57) ABSTRACT

A double side visible type liquid crystal display device having one sheet of panel a displayed image on which can be observed from either of a front surface and a back surface is realized in a thin and inexpensive construction. Thus, in the liquid crystal display device of the present invention, a displayed image on a single liquid crystal panel can be observed from either of a front surface and a back surface. That is, the liquid crystal display device includes a liquid crystal panel having substrates which holds a liquid crystal layer therebetween, a first polarizer, and a second polarizer which are disposed so as to sandwich the liquid crystal panel, and transflector provided between the liquid crystal layer and the second polarizer, for reflecting incident light at a predetermined rate and for transmitting the remaining light. Moreover, a first optical compensator is disposed between the first polarizer and the liquid crystal layer, and a second optical compensator are disposed between the transflector and the second polarizer, respectively.

### BACKGROUND OF THE INVENTION

Field of the Invention

The present invention relates in general to a liquid crystal display device for use in electronic apparatuses such as a watch, a mobile telephone and an audio system. In particular, the present invention relates to a liquid crystal display device in which a displayed image on one display element can be visually recognized either from a front surface side or a back surface side in correspondence to a situation.

In recent years, a liquid crystal element having the features as thinness and lightness has been widely used in mobile telephones and the like. In particular, display elements being used in mobile telephones are required to be compact and lightweight, so a liquid crystal display element is used in many mobile telephones. However, the liquid crystal display element is a photoreceptor device, so the liquid crystal display element has a problem in visibility in a dark place which the mobile telephone is required to perform. Therefore, a light unit is installed on a front surface side or a back surface side of the liquid crystal display element in many cases. In general, the former light unit is called a front light, and the latter light unit is called a back light. A schematic cross sectional view of a light unit of a front light system is shown in FIG. 10. As shown in FIG. 10, a front light includes a light source 14 and a light guiding plate 15. Light from the light source 14 is guided to a lower side (display panel side) through the light guiding plate 15 to be reflected by a reflector 16 provided in the back of a liquid crystal panel 1. Thus, a displayed image on the liquid crystal panel 1 can be visually recognized. In addition, light from the outside is transmitted through the light guiding plate 15 to be made incident to the liquid crystal panel 1. Thus, similarly to the case of the foregoing, a displayed image on the liquid crystal panel 1 can be visually recognized. On the other hand, a schematic cross sectional view of a display device of a back light system is shown in FIG. 11. Aback light includes a light source 14 and a light guiding plate 17, and is installed on a lower side of the liquid crystal panel 1. Light from the light source 14 of the back light is transmitted through the light guiding plate 17 to be reflected to the upper side to be applied to the liquid crystal panel 1. Thus, a displayed image on the liquid crystal panel 1 is visually recognized by an observer. As described above, the feature in a construction of the light guiding plate 15 of the front light is such that the reflected light from the reflector 16 is transmitted through the light guiding plate 15. On the other hand, the light guiding plate 17 of the backlight merely diffuses and reflects the light, and hence cannot transmit the light. However, in recent years, a folding construction has been adopted for the mobile telephones. Thus, in order that information such as a time or an incoming call may be displayed even when the mobile telephone is being folded, the number of mobile telephones each adopting a display device (sub display device), independently from a display device for a main display, for observation from a back surface side of a display device for the main display has increased. As an example, FIG. 12 schematically shows a construction of a liquid crystal display device for a mobile telephone, including a front light and a liquid crystal panel 1 for the main display and a backlight and a liquid crystal panel 18 for the sub display. A transflective plate 19 is provided between a light guiding plate 17 and the liquid crystal panel 18 of the back light as may be necessary.

In addition, as for a display device in which a displayed image thereon can be observed from the both sides using one sheet of liquid crystal panel, there is such a construction that a light guiding layer is disposed on a back surface side of a liquid crystal panel, and a reflector is disposed in a partial area on a front surface side of the liquid crystal panel, and thus a displayed image on this partial area can be observed from the back surface side as well (refer to JP 2002-132189 A for example).

In the conventional liquid crystal display device constructed as shown in FIG. 12, the display element for the sub display is newly required in addition to the display element for the main display. Then, the display element for the main display and the display device for the sub display are put one on top of the other, so there encounters a problem in that a total thickness of the liquid crystal display device increases, and thus the apparatus itself such as a mobile telephone becomes thicker. In addition, since a driving circuit and a light unit for the sub display element are specially required separately from those for the main display element, a problem in cost is also serious. In addition, in the case where a reflected light component not suffering from the optical modulation by the liquid crystal display element is also made incident to the observation surface as in the case where a transflective plate is disposed in the outside to observe a transmitted image, there also encounters a problem that the visibility for the displayed image is impaired.

Moreover, in the case of the liquid crystal display device having the construction described in JP 2002-132189 A, a portion of the displayed image observed from the back surface side does not participate at all to the display on the front surface side. As a result, a size of the display element becomes large with respect to the display screen.

### SUMMARY OF THE INVENTION

As described above, with the conventional construction, it was impossible to construct a liquid crystal display device in which the main display and the sub display can be carried out with excellent visibility while reducing thickness and cost.

In the light of the foregoing, an object of the present invention is to provide a thin and inexpensive liquid crystal display device in which display can be made on both sides of a front surface and a back surface.

A liquid crystal display according to the present invention is constructed such that a displayed image on a single liquid crystal panel can be observed from either side thereof. That is, a liquid crystal display device includes: a liquid crystal panel having a liquid crystal layer held between substrates; a first polarizer and a second polarizer disposed so as to sandwich the liquid crystal panel; and a transflector provided between the liquid crystal layer and the second polarizer, which has a function for reflecting incident light at a predetermined rate and for transmitting the remaining light. Here, the transflector is a transmission-mirror for reflecting the incident light at a predetermined rate irrespective of polarized light components and for transmitting the light other than the reflected light.

Further, a first optical compensator is provided between the first polarizer and the liquid crystal layer, and a second optical compensator is provided between the second polarizer and the transflector. Here, a reflection-polarizing plate for reflecting a polarized light component in a specific direction and for transmitting the remaining polarized light components is provided outside the second optical compensator instead of the transflector and the second polarizer.

Here, a direction of a reflection axis of the reflection-polarizing plate is set in the same direction as either of a polarization direction of light which is converted with its polarization direction by the liquid crystal layer to be emitted from the liquid crystal panel, or a polarization direction of light which is emitted from the liquid crystal panel without being converted with its polarization direction by the liquid crystal layer.

Further, a second polarizer having an absorption axis in the same direction as that of the reflection axis of the reflection-polarizing plate is provided outside thereof.

Here, the first optical compensator has characteristics for optically compensating for the second optical compensator.

In another case, the first optical compensator is a retardation plate that has characteristics not only for optically compensating for the second optical compensator but also for compensating for modulation by the liquid crystal layer.

Here, the first optical compensator includes a (2n−1)/4 wave plate (n: natural number), and the second optical compensator includes a (2m−1)/4 wave plate (m: natural number).

Further, the transflector is formed inside the liquid crystal panel. The transflector may be any one of a dielectric multi-layer film having a predetermined transmittance, a metallic film layer having a predetermined transmittance, and a transmission mirror having an opening portion in a position corresponding to a pixel portion of a display panel.

The following construction can be shown as an example of the construction where the transflector is formed inside the liquid crystal panel. That is, the liquid crystal panel has a transparent substrate and a counter substrate between which the liquid crystal is held, the first polarizer is provided outside the transparent substrate side, the second polarizer is provided outside the counter substrate, the transflector is provided on the counter substrate, and a counter electrode is formed on the transflector through an insulating film. In another case, the liquid crystal panel has a transparent substrate having a transparent electrode for driving formed thereon and a counter substrate having a counter electrode for driving formed thereon, while the liquid crystal layer is being held between the transparent substrate and the counter substrate, the first polarizer is provided outside the transparent substrate side, the second polarizer is provided outside the counter electrode side, and the transflector is provided on an upper surface or a lower surface of the counter electrode so as to maintain electrical independency of the counter electrode.

A driving circuit is also provided for processing a conversion of a signal to be applied to the display panel to supply the resultant signal to the liquid crystal panel depending on which of the first polarizer side or a side opposite to the first polarizer side the liquid crystal panel is observed from. Thus, it becomes possible to visually recognize the character information from either side of the front or back surface.

In addition, a front light type light unit is provided outside the first polarizer for irradiating with light from the first polarizer side to the liquid crystal panel.

According to the liquid crystal display device of the present invention, one sheet of liquid crystal display panel can be observed from both sides of a front surface and a back surface. Therefore, it becomes possible to make the display device to be thinner. Moreover, a diffusion layer is provided between the liquid crystal panel and the second polarizer, whereby a range of a visual angle can be widened even when a displayed image on the liquid crystal display device is observed from either side of the front surface or the back surface. In addition, the optical compensators are provided between the liquid crystal panel and the first polarizer, and between the liquid crystal panel and the second polarizer, respectively, whereby an image which is excellent in visibility can be obtained even when a displayed image on the liquid crystal display device is observed by being observed from either side of the front or-the back surface.

### BRIEF DESCRIPTION OF THE DRAWINGS

In the accompanying drawings:

FIG. 1 is a cross sectional view schematically showing a construction of a liquid crystal display device according to Embodiment 1 of the present invention;

FIG. 2 is a cross sectional view schematically showing a construction of a liquid crystal display device having a light unit;

FIG. 3 a cross sectional view schematically showing a construction of a liquid crystal display device according to Embodiment 2 of the present invention;

FIG. 4 is a cross sectional view schematically showing an example of a construction of a liquid crystal panel which has therein a transflective layer and which is used in the present invention;

FIG. 5 is a cross sectional view schematically showing another example of a construction of a liquid crystal panel which has therein a transflective layer and which is used in the present invention;

FIG. 6 is a cross sectional view schematically showing still another example of a construction of a liquid crystal panel which has therein a transflective layer and which is used in the present invention;

FIG. 7 is a cross sectional view schematically showing a construction of a liquid crystal display device according to Embodiment 3 of the present invention;

FIG. 8 is a cross sectional view schematically showing a construction of a liquid crystal display device according to Embodiment 4 of the present invention;

FIG. 9 is a graphical representation showing the characteristics of a directive diffusion layer used in the present invention;

FIG. 10 is a cross sectional view schematically showing a construction of a conventional liquid crystal display device including a front light;

FIG. 11 is a cross sectional view schematically showing a construction of a conventional liquid crystal display device including a backlight;

FIG. 12 is a cross sectional view schematically showing a construction of a conventional liquid crystal display device in which main display and sub display can be carried out;

FIG. 13 is a cross sectional view schematically showing a construction of a liquid crystal display device according to Embodiment 5 of the present invention;

FIG. 14 is a cross sectional view schematically showing a construction of a liquid crystal display device having a light unit;

FIG. 15 is a cross sectional view schematically showing a construction of a liquid crystal display device according to Embodiment 6 of the present invention;

FIG. 16 is a cross sectional view schematically showing a construction of a liquid crystal display device which is obtained by providing a second polarizer in the liquid crystal display device according to Embodiment 6 of the present invention;

FIG. 17 is a cross sectional view schematically showing a construction of a liquid crystal display device according to Embodiment 7 of the present invention;

FIG. 18 is a cross sectional view schematically showing a construction of a liquid crystal display device according to Embodiment 8 of the present invention;

FIG. 19 is a cross sectional view schematically showing a construction of a liquid crystal display device according to Embodiment 9 of the present invention;

FIG. 20 is a cross sectional view schematically showing a construction of an embodiment of a liquid crystal panel which has in its internal surface a partial reflector and which is used in the present invention;

FIG. 21 is a cross sectional view schematically showing a construction of an embodiment of a liquid crystal panel which has in its internal surface a partial reflector and which is used in the present invention;

FIG. 22 is a cross sectional view schematically showing a construction of an embodiment of a liquid crystal panel which has in its internal surface a partial reflector and which is used in the present invention; and

FIG. 23 is a cross sectional view schematically showing a construction of an embodiment of a liquid crystal panel which has in its internal surface a partial reflector and which is used in the present invention.

### DETAILED DESCRIPTION OF THE PREFERRED EMBODIMENTS

A liquid crystal display device of the present invention includes a liquid crystal panel having a liquid crystal layer held between substrates, first and second polarizers disposed so as to sandwich the liquid crystal panel, and a transflector having a function for reflecting incident light at a predetermined rate in the rear of the liquid crystal layer with respect to a direction along which light to be observed is made incident and for transmitting the remaining light of the incident light. The liquid crystal layer has a portion for converting a polarization direction of incident light to emit the resultant light, and a portion for emitting incident light as it is without converting a polarization direction of the incident light. Light and darkness of display are controlled in those portions to allow a displayed image on the liquid crystal panel to be recognized as an image. With the provision of the transflector as described above, the displayed image can be observed from a side of the second polarizer (at a second visual point) as well as from a side of the first polarizer (at a first visual point) with only the light incident from the side of the first polarizer to the liquid crystal panel. That is, the double side display becomes possible with one sheet of liquid crystal panel. Here, a visual point at an observer from a side of a reflection display surface on which an image is displayed with the reflected light is referred to as the first visual point, and a visual point at an observer from a side of a transmission display surface on which an image is displayed with the transmitted light is referred to as the second visual point. At this time, when the first visual point is located in a position of regular reflection with respect to an incident angle of the incident light, the brightest display can be observed. In addition, when the second visual point is located on a straight line with respect to an incident angle of the incident light, the brightest display can be observed.

In addition, a transmission-mirror for reflecting the incident light at a predetermined rate irrespective of the polarized light components and for transmitting light other than the reflected light maybe used as the transflector. Here, as for a concrete disposition place of the transflector, the inside of the liquid crystal panel or a space defined between the second polarizer and the liquid crystal panel can be exemplified. In addition, the transflector has to be provided with a function for reflecting the incident light at a predetermined rate and for transmitting the remaining light. Thus, a transflective reflecting layer may be provided inside the panel, or a transflective reflector may be provided between the liquid crystal panel and the second polarizer.

In addition, a diffusion layer is provided between the liquid crystal panel and the second polarizer. Adoption of such a construction results in that light is scattered by the diffusion layer to reach each visual point. Thus, a range of a visual angle in each visual point is widened.

Also, a directive diffusion layer is provided instead of the diffusion layer between the liquid crystal panel and the second polarizer. Moreover, the directive diffusion layer is used so that the scattered light has the directivity in a specific direction.

Furthermore, a liquid crystal display device of the present invention includes a liquid crystal panel having a liquid crystal layer-held between substrates, first and second polarizers disposed so-as to sandwich the liquid crystal panel, a transflector having a function for reflecting incident light at a predetermined rate in the rear of the liquid crystal layer with respect to a direction along which light to be observed is made incident and for transmitting the remaining light of the incident light, a first optical compensator provided between the liquid crystal layer and the first polarizer, and a second optical compensator provided between the transflector and the second polarizer. When the displayed image is observed from the second visual point, if light such as outside light is made incident from the second visual point side to the display panel, then this incident light is converted into linearly polarized light to be reflected by a transmission-mirror 3 when passing through the second polarizer. The reflected light is transmitted through the second polarizer, reaching an observer from the second visual point. That is, not only a displayed image with the incident light from the first visual point, but also the reflected light of the outside light from the second visual point side reach the second visual point. Thus, the displayed image is observed which is low in contrast and poor in visibility. Then, as described above, the construction is adopted in which the first optical compensator is provided between the liquid crystal layer and the first polarizer, and the second optical compensator is provided between the transmission-mirror and the second polarizer. According to such a construction, when passing through the second polarizer, the light incident from the second visual point side is converted into linearly polarized light having a polarization direction in a direction of a transmission axis of the second polarizer to be made incident to the second optical compensator. This linearly polarized light is converted into circularly polarized light or elliptically polarized light by the second optical compensator to be reflected by a partial reflecting film. The circularly polarized light or the elliptically polarized light having a polarization direction changed by the reflection, when passing through the second optical compensator again, is converted into the linearly polarized light. At this time, the polarization direction of the resultant linearly polarized light does not agree with the transmission axis of the second polarizer. Hence, the light which has passed through the second optical compensator again is not transmitted through the second polarizer, but is absorbed by the second polarizer. That is, the light incident from the second visual point side to be reflected by the transmission-mirror does not reach an observer from the second visual point. Thus, an image excellent invisibility can be observed from the second visual point side irrespective of the environment on the second visual point side (whether the environment is bright or dark). However, the linearly polarized light which is obtained by transmitting the light incident from the first polarization side through the transmission-mirror is converted into the circularly polarized light or the elliptically polarized light in the second optical compensator, and the circularly polarized light or the elliptically polarized light then reaches the second visual point via the second polarizer. Thus, the displayed image excellent in contrast can not be obtained from the second visual point only with the second optical compensator. That is, since only one optical compensator is present between the first and second polarizers, the excellent transmission display is not obtained from the second visual point. In order to prevent this, the first optical compensator for further compensating for the modulation by the second optical compensator needs to be provided between the first polarizer and the liquid crystal panel. According to such a construction, even when the displayed image is observed from either the front surface side or the back surface side, an image excellent invisibility can be obtained. That is, the incident light passing through the first polarizer is converted into the linearly polarized light in a specific direction, and is then converted into the circularly polarized light or the elliptically polarized light in the first optical compensator to be made incident to the liquid crystal panel. The light incident to the liquid crystal panel is modulated in the liquid crystal layer and is then transmitted through the transmission-mirror. Then, as described above, the light transmitted through the transmission-mirror reaches the second visual point, while the light reflected by the transmission-mirror reaches the first visual point. In addition, when the appearance of the reflection display at the first visual point is regarded as important, the first optical compensator may have not only a function for compensating for the modulation by the second optical compensator, but also a function for compensating for the modulation for the light by the liquid crystal layer.

Here, an operation will hereinafter be described by giving as an example a case where a (2n−1)/4 wave plate (n: natural number) is used-as the first optical compensator, and a (2m−1)/4 wave plate (m: natural number) is used as the second optical compensator. The light, which has passed through the first polarizer, becomes the light that contains only the linearly polarized light component biased in a direction of the polarization axis. The linearly polarized light component is converted into the circularly polarized light in the (2n−1)/4 waveplate (n: natural number). The resultant circularly polarized light is modulated in correspondence to a voltage applied to the liquid crystal layer of the liquid crystal panel. The light which has passed through the liquid crystal layer to be reflected by the transmission-mirror passes through the liquid crystal layer again to be converted into the linearly polarized light in the (2n-1)/4 wave plate. The resultant linearly polarized light passes through the first polarizer to reach the first visual point. On the other hand, the light which has passed through the transmission-mirror is converted into the linearly polarized light again in the (2m−1)/4 wave plate (m: natural number) to reach the second polarizer. The polarization direction of the linearly polarized light is rotated by an angle corresponding to the amount of modulation by the liquid crystal layer with respect to the polarization direction of the linearly polarized light right after passing through the first polarizer. Thus, the transmission axis of the second polarizer must be set so as for the second polarizer to transmit this light.

Here, more specifically, a ¼ wave plate, a ¾ wave plate, and a 5/4 wave plate etc. are used as the (2n−1)/4 wave plate and the (2m−1)/4 wave plate. For example, it is possible to use a polymeric film, with a predetermined double refraction given thereto by extending high polymer in a specific direction, with its thickness being controlled. In another case, the existing ¼ wave plate and the existing ½ wave plate can be used in combination to realize an element having the same operation as that of the above-mentioned wave plate. Note that the natural numbers n and m may be equal to each other or may be different from each other.

In addition, instead of the second polarizer, a reflection-polarizing plate having a function for reflecting a polarized light component in a specific direction and for transmitting the remaining polarized light component is used. That is, a liquid crystal display device of the present invention is constructed of a liquid crystal panel having a liquid crystal layer held between mutually-opposite transparent substrates through first and second transparent electrodes, a first polarizer provided on one side of the liquid crystal panel, a reflection-polarizing plate provided on the other side of the liquid crystal panel for reflecting a polarized light component in a specific direction and for transmitting the remaining polarized light components, a first optical compensator provided between the first polarizer and the liquid crystal layer, and a second optical compensator provided between the reflection polarizer and the liquid crystal layer. With such a construction, a displayed image can be observed both from a reflection display surface and a transmission display surface without using a partial reflector.

In addition, a diffusion layer is provided between the liquid crystal panel and the second polarizer. With such a construction, the light is scattered by the diffusion layer to reach each visual point, whereby a range of a visual angle from each visual point is widened. In addition, instead of the diffusion layer, a directive diffusion layer is provided between the liquid crystal panel and the second polarizer. Also, the directive diffusion layer is set so that the scattered light has the directivity in a specific direction.

In addition, the liquid crystal display device is provided with a driving circuit for processing a conversion of a signal to be applied to the display panel to supply the resultant signal to the liquid crystal panel depending on which of the first and second visual points the liquid crystal panel is observed from, which makes it possible to set the display format freely on the front and back surface sides independently. For example, mirror characters reversed in a right-left direction, or in a vertical direction can be converted into regular characters by executing a processing such as for changing a scanning direction of a signal. In addition, a negative/positive image can also be converted. Thus, the display format can be set so that the same image (e.g., regular characters displayed in a negative form or a positive form) can be observed by being viewed from either side of the front and the back surface.

As described above, the liquid crystal display device of the present invention can be utilized in a double side visible type liquid crystal display device where a displayed image can be visually recognized from each side of a front and a back surface in correspondence to the situation, and hence is adopted in electronic apparatuses such as a watch and a mobile telephone.

Embodiments 1 to 9 of a liquid crystal display device of the present invention will hereinafter be described in detail with reference to the accompanying drawings.

(Embodiment 1)

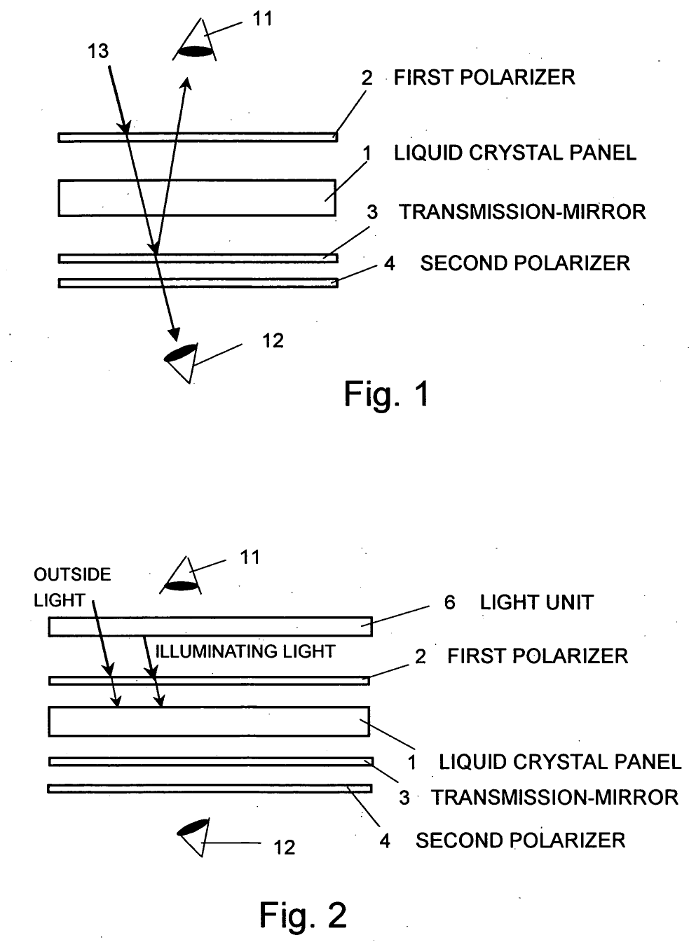

A construction of a liquid crystal display device according to Embodiment 1 is schematically shown in FIG. 1. As shown in the figure, a liquid crystal panel 1 is disposed between a first polarizer 2 and a second polarizer 4. In addition, a transmission-mirror 3 as a transflector is disposed between the second polarizer 4 and the liquid crystal panel 1. The liquid crystal panel 1 has a construction in which a liquid crystal layer is held between the transparent substrates such as a glass substrate or a plastic substrate. A suitable voltage is applied to the liquid crystal layer through transparent electrodes for display formed on each of the transparent substrates to control arrangement of liquid crystal molecules, thereby realizing display of an image. Here, each of the first and second polarizers has a function for absorbing a specific linearly polarized light component and for transmitting remaining polarized light components. In addition, the transmission-mirror 3 has a function for reflecting incident light at a predetermined rate irrespective of the polarized light components and for transmitting the remaining light of the incident light. Note that a visual point of an observer on a side of the first polarizer 2 is called a first visual point 11, and a visual point of an observer on a side of the second polarizer 4 is called a second visual point 12.

First of all, the principle of an operation of the liquid crystal display device constructed as described above will hereinafter be described by giving as an example a case where light is made incident from the first polarizer 2 to the liquid crystal panel 1. As for incident light 13 from the first polarizer 2, when passing through the first polarizer 2, its linearly polarized light in a direction of an absorption axis is absorbed by the first polarizer 2, and the remaining transmission components are made incident to the liquid crystal panel 1. The light incident to the liquid crystal panel 1 is converted with its polarization direction in correspondence to a twist angle of the liquid crystal molecules in an off area (an area having no voltage applied) of the liquid crystal layer to be emitted from the liquid crystal panel 1. Of the light thus emitted, the light reflected by the transmission-mirror 3 is made incident to the liquid crystal layer again. On the other hand, in an on area (an area having a voltage applied) of the liquid crystal layer, the light passes through the liquid crystal panel 1 at a rate corresponding to the magnitude of the applied voltage with the same polarization direction as that of the incident light. Then, a part of the light which has passed through the liquid crystal panel 1 is reflected in accordance with the spectral reflection characteristics of the transmission-mirror 3, and the remaining part passes through the transmission-mirror 3. In this case, when the polarization axis of the light passed through the off area of the liquid crystal panel 1 is aligned in direction with the polarization axis of the second polarizer 4, as shown in FIG. 1, among the light passed through the liquid crystal panel 1, the light component reflected by the transmission-mirror 3, in the off area, passes through the liquid crystal layer again to reach the first polarizer 2, as the light having the same polarization axis as that of the first polarizer 2, to enter the first visual point 11. On the other hand, among the light transmitted through the liquid crystal panel 1, the light component transmitted through the transmission-mirror 9 enters the second visual point 12, as the light having the polarization axis different from that of the reflected light, because the light component passed through the liquid crystal layer only once. Consequently, in a case where the liquid crystal is initially oriented so as to obtain a white display mode (i.e., a normally white display mode) in the off time when viewed from the first visual point 11, when the first and second polarizers 2 and 4 are disposed so that their polarization axes are orthogonal to each other, an image observed from the first visual point 11 and from the second visual point 12 will show the positive/negative inversion relationship. Thus, the data conversion by a driving circuit is required depending on from which of the first or second visual point an image is observed. In addition, in a case where the liquid crystal is initially oriented so as to obtain a black display mode (i.e., a normally black display mode) in the off time when viewed from the first visual point 11, when the first and second polarizers 2 and 4 are disposed so that their polarization axes are parallel with each other, though an image observed from the first visual point 11 and an image observed from the second visual point 12 will not show the positive/negative inversion relationship, the sufficient contrast cannot be obtained. Consequently, in order that an image observed from the first visual point 11 may be made to agree in quality with an image observed from the second visual point 12, for example, it is preferable to contrive such a means that a thickness of the liquid crystal layer constituting the liquid crystal panel 1 is optimized when an image is observed from the second visual point 12, and a driving voltage for observing an image from the first visual point 11 is reduced to half of that for observing an image from the second visual point 12.

In addition, as shown in FIG. 2, a front light type light unit 6 may be provided above the first polarizer 2 so that a displayed image can be visually recognized even when there is no outside light incident from the first visual point side. Here, the front light type light unit 6 has a function for irradiating with illuminating light to the liquid crystal panel 1 and for transmitting the light vertically. That is, the front light type light unit 6 has a transmission function for transmitting the outside light incident from the side of the first visual point 11 to introduce the outside light to the liquid crystal panel, and a light emission function for emitting illuminating light from a built-in light source to the liquid crystal panel. Thus, under the environment in which the outside light having sufficient brightness is obtained, the transmission function is utilized, while under the environment in which the outside light having sufficient brightness is not obtained, the light emission function is utilized.

In addition, in the liquid crystal display device constructed as described above, when an image to be observed from the first visual point 11 is observed as it is from the second visual point 12, it causes not only the positive/negative inversion, but also the image to become mirror characters reversed in a right-left direction or in a vertical direction depending on the directions from the visual angle from which the liquid crystal panel is observed. Consequently, in order to observe the same image from the first and second visual points, the liquid crystal display device has to include the driving circuit for driving the liquid crystal panel 1 having a function for executing the processing such as for changing the scanning direction of a signal to supply the resultant signal to the liquid crystal panel depending on from which of the first or second visual point an image is observed.

### CONCRETE EXAMPLE 1

A concrete example of the transmission-mirror used in the liquid crystal device having the construction shown in FIG. 1 will hereinafter be described. On a PET, Al was formed into a thickness of 50 to 200 Å by utilizing a vacuum evaporation method to obtain a transmission-mirror having a rate of transmittance of 16 to 64%. In addition, as the result of observing a liquid crystal display device having a front light type light unit disposed on the first polarizer 22 side, an excellent color image could be observed either from the first visual point or the second visual point. Here, a conventional translucent type TFT liquid crystal panel can also be used as a liquid crystal panel to obtain the same effect as described above.

(Embodiment 2)

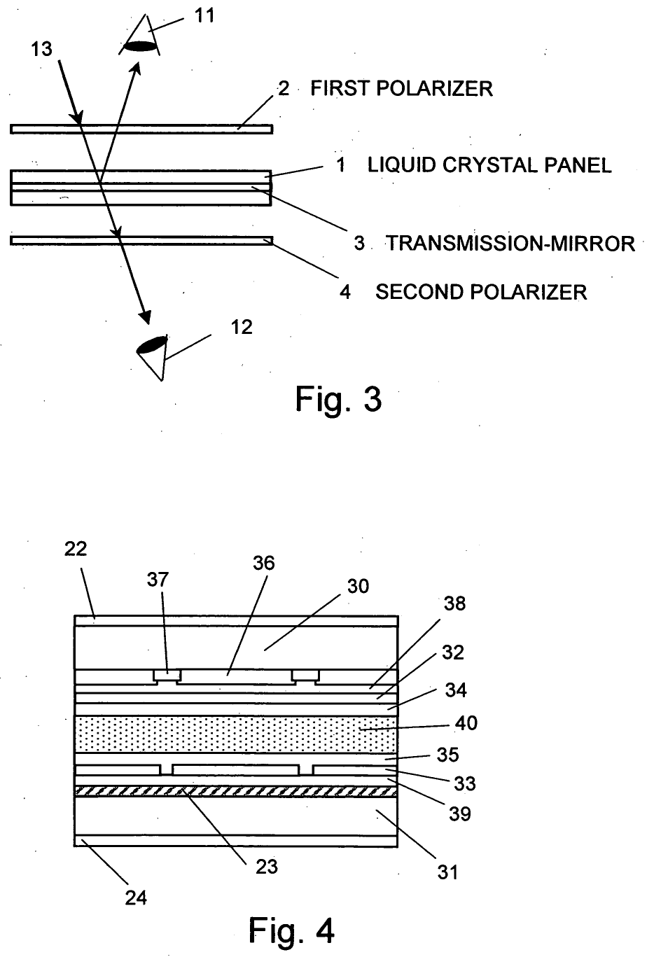

A construction of a liquid crystal display device according to Embodiment 2 is schematically shown in FIG. 3. Embodiment 2 has different construction from Embodiment 1 in that a transmission-mirror 3 is disposed inside the liquid crystal panel 1. The description overlapping that of Embodiment 1 is omitted here for the sake of simplicity. According to the construction of Embodiment 3, due to the short distance between the liquid crystal layer and the transmission-mirror 3, when an image is observed with the reflected light from the first visual point, it is effective to make a parallax between pixels to be smaller than that in the liquid crystal display device according to Embodiment 1.

Next, a description will hereinafter be given with respect to a construction of the liquid crystal panel with the transmission-mirror 3 is formed therein with reference to FIGS. 4 to 6. FIG. 4 schematically shows an example of a construction in which a transreflective layer is formed as the transmission-mirror within a simple matrix type color liquid crystal panel. As shown in the figure, a color filter 36 and a light shielding layer 37 are formed on a lower surface of a transparent substrate 30. Also, transparent electrodes 32 are formed on a lower side of the color filter 36 and the light shielding layer 37 through a flattening layer 38. Moreover, a transflective layer 23 is formed on an upper surface of a counter substrate 31, and counter electrodes 33 are formed on the transflective layer 23 through an insulating film 39. Transparent electrodes 32 and the counter electrodes 33 are disposed so as to be orthogonal to each other. Pixels are defined at intersection portions between the transparent electrodes 32 and the counter electrodes 33. Then, a first orientation film 34 is formed so as to cover lower surfaces of the transparent electrodes 32 and a second orientation film 35 is formed so as to cover upper surfaces of the counter electrodes 33. The first and second orientation films 34 and 35 regulate a direction of orientation of the liquid crystal molecules of the liquid crystal layer 40. In this example, first and second polarizers 22 and 24 are stuck to outer surfaces of the transparent substrate 30 and the counter substrate 31 using a pressure sensitive adhesive, respectively. According to such a construction, the light incident from the first polarizer 22 side to the transparent substrate 30 is successively transmitted through the transparent substrate 30, the color filter 36, the flattening layer 38, the transparent electrodes 32, the first orientation film 34, the liquid crystal layer 40, the second orientation film 35, the counter electrode 33, and the insulating film 39 to reach the transflective layer 23. A part of the light arriving at the transflective layer 23 is reflected to be returned back to the liquid crystal layer 40 again, while the remaining part thereof is directly transmitted through the counter substrate 31 to reach the second polarizer 24. As a result, a color image can be observed from both of the first and second visual points.

Here, even when the transflective layer 23 is made of Al or Ag, or a metallic compound containing Al and Ag as the basic constituent, the transflective layer 23 has only to be formed in the form of a thin film without the fine patterning thereof because the transflective layer 23 is electrically separated from the counter electrodes 33 through the insulating film 39. In addition, when the transflective layer 23 is made of an insulator such as a dielectric multi-layer film, the insulating film 39 can be omitted.

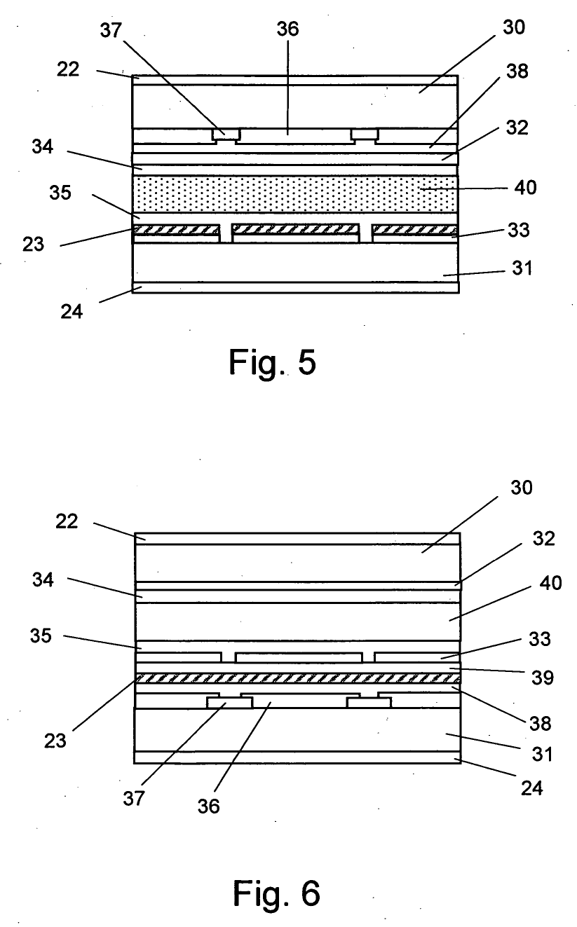

Next, FIG. 5 shows another example of the liquid crystal panel in which transflective layers 23 are directly formed on counter electrodes 33. The transflective layers 23 are formed so as to correspond in shape to the counter electrodes 33 through the fine patterning process. At this time, when the transflective layer 23 is made of Al or Ag, or a metallic compound containing Al and Ag as the basic constituent, the transflective layer 23 has a function not only for reflecting and transmitting the light, but also for increasing an electric conductivity of each of the counter electrodes 33 to reduce the power consumption. Note that in this example, the description has been given with respect to the case where the transflective layers 23 are directly formed on the upper surfaces of the counter electrodes 33 respectively, though the transflective layers 23 may also be directly formed on lower surfaces of the counter electrodes 33 so as to correspond in shape to the counter electrodes 33 through the fine patterning process. Of course, when each of the transflective layers 23 is formed of a dielectric multi-layer film, it is unnecessary to form the transflective layers 23 so as to correspond in shape to the counter electrodes 33 through the fine patterning process.

Next, an example of the liquid crystal panel shown in FIG. 6 has different construction from the examples of the liquid crystal panels shown in FIGS. 4 and 5 in that a transflective layer 23 is formed between a color filter 36 and counter electrodes 33. With this construction, a flattening layer 38 may be omitted. In addition, when the transflective layer 23 is made of an insulator such as a dielectric multi-layer film, an insulating film 39 may be omitted. In the case of the construction shown in FIG. 6, when the transmitted light of the light incident from the first polarizer 22 side is observed from the second polarizer 24 side or the transmitted light of the light incident from the second polarizer 24 side is observed from the first polarizer 22 side, a color image can be obtained. On the other hand, when the light reflected by the transflective layer 23 is observed, among the light incident from the first polarizer 22 side, on the first polarizer 22 side, a monochrome image can be obtained. The monochrome image obtained at this time does not pass through the color filter 36 on the way, so the monochrome image can be obtained as a bright image. Thus, an image can be recognized without using illuminating light from a light unit, which is very effective in reducing the power consumption. Note that in the case of the construction shown in FIG. 6, a front light type unit needs to be disposed outside the first polarizer 22.

Above, the description has been given with respect to the concrete examples in each of which the transflective layer 23 is formed within the simple matrix type color liquid crystal panel. However, this construction may also be applied to an active matrix type liquid crystal device in which thin film transistors (TFTs) and thin film diodes are disposed in each of the pixels.

### CONCRETE EXAMPLE 2

A concrete example of the transflective layer 23 used in the liquid crystal panel having the construction shown in FIG. 4 will hereinafter be described. A film made of a metallic compound containing Ag and Pd was formed into a thickness of 50 to 200 \acute{Å} by utilizing a vacuum evaporation method to obtain a transflective layer having a transmittance of 20 to 80%. In addition, as the result of observing a liquid crystal display device having a front light type light unit disposed on the first polarizer 22 side, an excellent color image could be observed either from the first visual point and the second visual point. When the transmittance of the transflective layer 23 was so high as to fall within a range of 60 to 80%, an image with the transmitted light was more brightly observed from the second visual point. On the other hand, when the transmittance of the transflective layer 23 was so low as to fall within a range of 20 to 40%, an image with the reflected light was more brightly observed from the first visual point.

### CONCRETE EXAMPLE 3

A concrete example of the transflective layer 23 used in the liquid crystal panel having the construction shown in FIG. 4 will hereinafter be described. λ/4 films containing silicon oxide and titanium dioxide were laminated alternately to form 4 to 9 layers by utilizing a vacuum evaporation method to obtain a transflective layer having a reflectivity of 40 to 80%. In addition, as the result of observing a liquid crystal display device having a front light type light unit disposed on the first polarizer 22 side, an excellent color image could be observed either from the first visual point and the second visual point. When compared to the case of concrete example 2 where a metallic thin film was used as a transflective layer, brightness of the image both by reflection and by transmission was similarly improved.

### CONCRETE EXAMPLE 4

A concrete example of the transflective layer 23 used in the liquid crystal panel having the construction shown in FIG. 5 will hereinafter be described. A film made of a metallic compound containing Ag and Pd was formed into a thickness of 50 to 200 Å through the sputtering process to obtain a transflective layer having a transmittance of 20 to 80%. In addition, as the result of observing a liquid crystal display device having a front light type light unit disposed on the first polarizer 22 side, an excellent color image could be observed either from the first visual point and the first visual point. When the transmittance of the transflective layer 23 was so high as to fall within a range of 60 to 80%, an image with the transmitted light was more brightly observed from the second visual point. On the other hand, when the transmittance of the transflective layer 23 was so low as to fall within a range of 20 to 40%, an image with the reflected light was more brightly observed from the first visual point. Also, with such a construction, an impedance of the liquid crystal driving electrodes could be reduced to a value which is substantially equal to a value as in the case where each driving electrode is made of a metal material, and hence it also becomes possible to obtain an excellent image free from the tailing.

### Embodiment 3

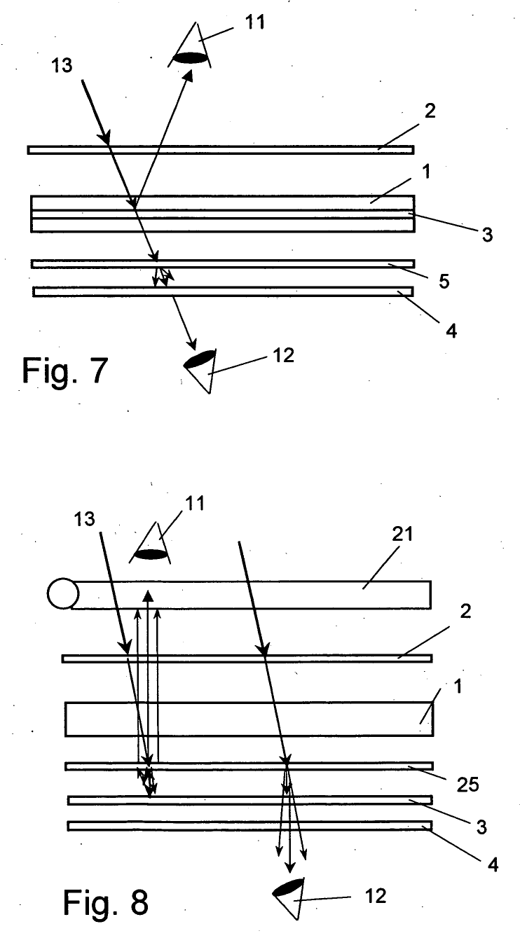

A construction of a liquid crystal display device according to Embodiment 3 is schematically shown in FIG. 7. Similarly to Embodiments 1 and 2 described above, a description will hereinafter be given by giving as an example a case where light is made incident from a first polarizer 2 side to a liquid crystal panel 1. Note that a description overlapping that of each of Embodiments 1 to 3 is suitably omitted for the sake of simplicity.

As shown in the figure, in Embodiment 3, the liquid crystal panel 1 having a transmission-mirror therein is disposed between the first polarizer 2 and the transmission-mirror 3, and the diffusion layer 5 is disposed between the liquid crystal panel 1 and the second polarizer 4. Here, the diffusion layer 5 has a function for scattering the light in a specific range when the light passes through the diffusion layer 5. Thus, by providing the diffusion layer 5, the light scattered by the diffusion layer 5 can reach the second visual point 12 by passing through the second polarizer 4 even when the second visual point 12 is not located on the extension of the straight line in a direction of incident light 13 with an incident angle. As a result, a range of a visual angle is widened for a second observer as well.

Consequently, even when the incident angle of the incident light 13, or a position of a visual point of an observer is changed (i.e., even when a relative position between the incident light 13 with the incident angle and an observation direction of an observer is changed), there still are the reflected light components or the transmitted light components which are obtained by scattering the incident light in various directions in the diffusion layer. This results in that a range of a visual angle of an observer is widened. In addition, when a front light type light unit is provided above the first polarizer 2, a displayed image can be visually recognized either of the visual points even under the dark environment.

### CONCRETE EXAMPLE 5

A concrete example of the diffusion layer 5 used in the liquid crystal panel having the construction shown in FIG. 7 will hereinafter be described. Acrylate beads having an average particle diameter of 10 μm were applied on a PET to obtain a diffusion plate having a haze value of 70%. In addition, the liquid crystal panel having the construction shown in Concrete Example 2 was used. As a result, an angle of visual field from the second visual point could be remarkably widened as compared with the double side visible type liquid crystal display device shown in Concrete Example 2.

### Embodiment 4

A construction of a liquid crystal display device according to Embodiment 4 is schematically shown in FIG. 8. In Embodiment 4, a directive diffusion layer 25 is provided instead of the diffusion layer 5 of Embodiment 3, and a transflective layer 3 is disposed between the directive diffusion layer 25 and a second polarizer 4. Similarly to Embodiments 1 to 3 described above, a description will hereinafter be given by giving as an example a case where light is made incident from a first polarizer 2 side to a liquid crystal panel 1. Note that a description overlapping that of each of Embodiments 1 to 3 is suitably omitted for the sake of simplicity.

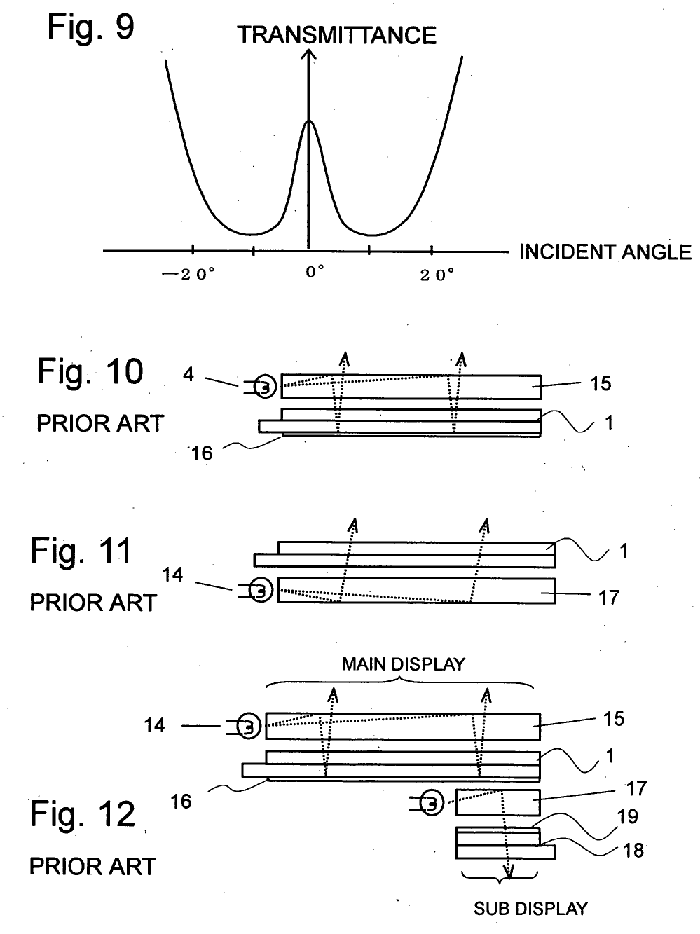

As shown in the figure, in Embodiment 4, the liquid crystal panel 1 is disposed between the first polarizer 2 and the transmission-mirror 3, and the directive diffusion layer 25 is disposed between the liquid crystal panel 1 and the transmission-mirror 3. In addition, a front light 21 for irradiating with illuminating light to the liquid crystal panel 1 is disposed as shown in the figure. The directive diffusion layer 25 has a function for scattering the light with a specific incident angle range and for directing the scattered light in a specific direction. That is, the directive diffusion plate 25 has the property for transmitting nearly the incident light from a thickness direction (normal line direction), for collecting effectively the diffused light which is obtained by diffusing the light with an incident angle of 5 to 15° in the thickness direction, i.e., to the front of an observer, and for transmitting nearly the incident light with an incident angle of equal to or larger than about 20° as a critical angle. Thus, the incident light 13 with the various incident angles can be observed from the first visual point 11 and hence the brightness is enhanced. FIG. 9 shows a relationship between an incident angle and a transmittance of the directive diffusion layer 25. In the figure, an incident angle of the light incident from the thickness direction (normal line direction) to the directive diffusion layer is expressed as 0°.

Here, let us consider a case where a displayed image is observed from the first visual point 11. In order to enhance the appearance of the display when a displayed image is observed with the outside light, the directive diffusion layer 25 is required to have excellent reflection characteristics. Thus, it is better to use the directive diffusion layer 25 showing the characteristics such as a low transmittance and large scattering. On the other hand, in order to enhance the appearance of the display when a displayed image is observed in low light using a front light, the directive diffusion layer 25 is required to have excellent transmission characteristics. Thus, it is better to use the directive diffusion layer 25 showing the characteristics such as a high transmittance and small scattering.

On the other hand, when a displayed image is observed from the second visual point 12, the directive diffusion layer 25 is required to have excellent transmission characteristics. Thus, it is better to use the directive diffusion layer 25 showing the characteristics such as a high transmittance and small scattering. In addition, when the directive diffusion layer 25 having such characteristics is used, the blur in a displayed image can be prevented.

In addition, a liquid crystal panel having a transmission-mirror formed therein may also be used. In this case, the directive diffusion layer 25 may be disposed between the liquid crystal panel 1 and the second polarizer 4.

Embodiment 5

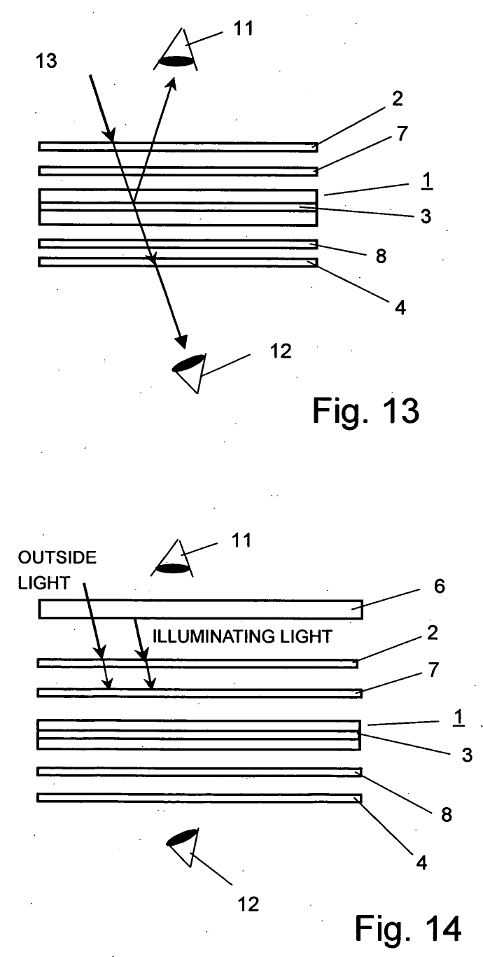

A construction of a liquid crystal display device according to Embodiment 5 is schematically shown in FIG. 13. As shown in the figure, in addition to the constituent elements of Embodiment 2 described with reference to FIG. 3, optical compensators are disposed between a liquid crystal panel 1 and each of the polarizers. That is, the liquid crystal panel 1 is disposed between the first and second polarizers 2 and 4, and a first optical compensator 7 and a second optical compensator 8 are disposed between the liquid crystal panel 1 and the first polarizer 2, and between the liquid crystal panel 1 and the second polarizer 4 respectively. The liquid crystal panel 1 has a construction in which a liquid crystal layer is held between transparent substrates such as a glass substrate or a plastic substrate. A suitable voltage is applied to the liquid crystal layer through the transparent electrodes for display formed on each of the transparent substrates to control the arrangement of the liquid crystal molecules, thereby realizing display of an image. That is, the liquid crystal layer has a portion for converting the polarization direction of the incident light to emit the resultant light, and a portion for emitting the incident light as it is without converting the polarization direction of the incident light. The display on the liquid crystal panel can be recognized as an image by making contrast between light and dark in those portions.

Here, each of the first and second polarizers has a function for absorbing a specific linearly polarized light and for transmitting a polarized light component intersecting perpendicularly the specific linearly polarized light component. In addition, a transmission-mirror 3 for reflecting a part of the incident light to the liquid crystal panel and for transmitting the remaining part of the incident light to the liquid crystal panel is provided inside the liquid crystal panel 1. The transmission-mirror 3 has a function for reflecting the light incident to the liquid crystal panel 1 at a predetermined rate irrespective of the polarized light components and for transmitting the remaining light. This transmission-mirror 3 is constituted by either a transflective layer having a predetermined reflectivity or a reflecting mirror in which an opening with a predetermined area is formed in a pixel area portion of the liquid crystal panel 1. When the transmission-mirror 3 is constituted by the reflecting mirror having the opening, the intensity of the reflected light is controlled based on a rate at which the pixel area is occupied by the area of the opening.

A construction in which a (2n−1)/4 wave plate is used as the first optical compensator 7, and a (2m−1)/4 wave plate is used as the second optical compensator 8 will hereinafter be described in detail. First of all, the principle of an operation of the liquid crystal display device having such a construction will hereinafter be described by giving as an example a case where light is made incident from the first polarizer 2 to the liquid crystal panel 1. Incident light 13 from the first polarizer 2 is absorbed with its linearly polarized light in a direction of an absorption axis of the first polarizer 2 when passing through the first polarizer 2, and the remaining transmission components are made incident to the liquid crystal panel 1. The light incident to the liquid crystal panel 1 is modulated in correspondence to an initial orientation state of the liquid crystal molecules in an off area (an area having no applied voltage) of the liquid crystal layer. On the other hand, in an on area (an area having an applied voltage) of the liquid crystal layer, the amount of light modulated by the liquid crystal panel 1 changes at a rate corresponding to the magnitude of the applied voltage on the pixels compared to the off area. Then, a part of the light which has modulated by the liquid crystal panel 1 is reflected, and the remaining part passes through the transmission-mirror 3. Here, a case is considered where an image on the reflection display surface becomes a white display mode, i.e., a so-called normally white mode, when an applied voltage is cut. As shown in FIG. 13, the light transmitted through the first polarizer 2 is converted therein into the linearly polarized light which is polarized in the same direction as that of a polarization axis of the first polarizer 2. This linearly polarized light passes through the (2n−1)/4 wave plate 7 to be modulated with its phase into a circularly polarized light. Note that this wave plate is disposed with a direction of its anisotropic axis being inclined by 45° (π/4) with respect to the first polarizer 2. Alight component, reflected by the transmission-mirror 3, of the circularly polarized light incident to an off area of the liquid crystal panel 1 is transmitted again through the liquid crystal layer to be modulated with its phase by π/2. The modulated light is then transmitted through the (2n−1)/4 wave plate 7 again to be returned back to the linearly polarized light again. The linearly polarized light becomes linearly polarized light having the same degree of polarization as that of the polarization axis of the first polarizer 2, the linearly polarized light is transmitted through the first polarizer 2 to enter the first visual point 11. On the other hand, a light component transmitted through the transmission-mirror 3, of the light transmitted through the liquid crystal panel 1, is transmitted through the liquid crystal layer to be phase-modulated by the liquid crystal layer. The phase-modulated light is then transmitted through the (2m−1)/4 wave plate 8 to become a linearly polarized light. The linearly polarized light is then transmitted through the second polarizer 4 to reach the second visual point 12.

Note that, when a partial reflector having a predermined opening in a position corresponding to the pixel portion is used as the transmission-mirror 3, a liquid crystal thickness of a portion of this partial reflector corresponding to a reflecting surface is set half of that of the opening portion, whereby an amount of polarization conversion of the reflected light can be made equal to that of the polarization conversion of the transmitted light. Thus, it is possible to reduce the nonconformity such as reduction of contrast.

On the other hand, in either of a case where the transmission-mirror is used or a case where a reflection-polarizing plate which will be described later is used without using the transmission-mirror, when an active matrix type liquid crystal panel adopting thin film transistors (TFTs) and the like is used as the liquid crystal panel 1, a part of metallic wirings used as wirings through which an image signal and an electric power are supplied to the thin film transistors is exposed to a part of the pixel area to serve as a reflecting mirror. In particular, the outside light which directly comes into eyes of an observer from these reflecting portions without passing through the liquid crystal layer (in general, referred to as “reflection”) becomes one of the causes for impairing the visibility and the image quality. Hereinafter, a description will be given with respect to the behavior of the light incident to the metallic wirings each made of Mo, Cr, or the like which are used as the wirings for the thin film transistors when the active matrix type liquid crystal panel adopting the thin film transistors is used as the liquid crystal panel 1. The light is modulated likewise as described above until the light is transmitted through the (2n−1)/4 wave plate 7. However, though a part of the metallic wirings is exposed to the pixel portion, this part does not have an operation for applying directly a driving voltage to the liquid crystal layer to modulate the light. Thus, though the light which has been transmitted through the (2n−1)/4 wave plate 7 to be reflected by the surfaces of the metallic wirings is phase-modulated by π upon being reflected by the surfaces of the metallic wirings, the light concerned is transmitted through the (2n−1)/4 wave plate 7 again without suffering any of the phase modulations at all other than the phase modulation by π. At this time, the linearly polarized light which has been transmitted through the (2n−1)/4 wave plate 7 intersects perpendicularly the polarization axis of the first polarizer 2. So the linearly polarized light is absorbed by the first polarizer 2, and it does not reach the first visual point. As a result, an image observed from the first visual point is obtained with only the light modulated in the liquid crystal layer. Therefore, the image has an excellent quality free from the reflection.

Likewise, in a case as well where the transmitted image is observed from the second visual point 12, even if the outside light incident from the second visual point 12 side is reflected by an internal reflection structure, all the reflected outside light is absorbed by the second polarizer 4 and hence exerts no influence on a transmitted image. Thus, an image excellent in quality can be observed from the second visual point 12.

A liquid crystal display device having a construction in which, in addition to the constituent elements shown in FIG. 13, a light unit is disposed on the first visual point 11 side is schematically shown in FIG. 14. A front light type light unit 6 is provided above the first polarizer 2 so that a displayed image can be visually recognized even when there is no outside light incident from the first visual point side. Here, the front light type light unit 6 has a function, as well as for irradiating with illuminating light to the liquid crystal panel 1, for transmitting vertically the light. That is, the front light type light unit 6 has the transmission function for transmitting the outside light incident from the side of the first visual point 11 to introduce the outside light to the liquid crystal panel, and a light emission function for emitting illuminating light from a built-in light source to the liquid crystal panel. Thus, in the display device constructed as shown in FIG. 14, under the environment in which the outside light having sufficient brightness is obtained, the transmission function of the light unit is utilized, while under the environment in which the outside light having sufficient brightness is not obtained, the light emission function of the light unit is utilized.

In addition, when in the liquid crystal display device constructed as described above, an image to be observed from the first visual point 11 is observed as it is from the second visual point 12, not only the positive/negative inversion is caused, but also the image becomes left and right mirror characters or vertical mirror-characters depending on the directions of the visual angle from which the liquid crystal panel is observed. Consequently, in order to observe the same image from the first and second visual points, the double side visible type liquid crystal device of the present invention includes, as the driving circuit for driving the liquid crystal panel 1, a driving circuit having a function for executing the processing for changing the scanning direction of a signal to supply the resultant signal to the liquid crystal panel depending on from which of the first or second visual point an image is observed.

(Embodiment 6)

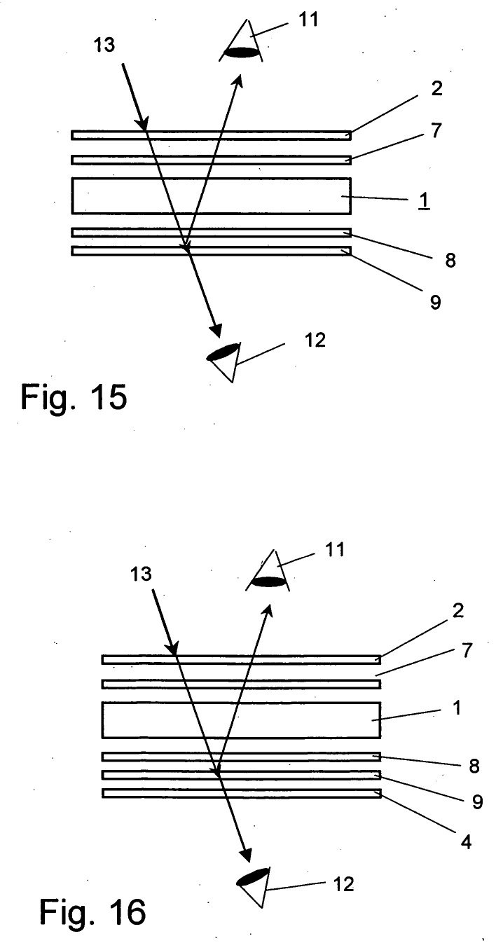

A construction of a liquid crystal display device according to Embodiment 6 is schematically shown in FIG. 15. Hereinafter, a description will be given by giving as an example a case where the light is made incident from a first polarizer 2 side similarly to Embodiments 1 to 5 described above. Note that a description overlapping that of each of Embodiments 1 to 5 is suitably omitted for the sake of simplicity. As shown in FIG. 15, in Embodiment 6, a reflection-polarizing plate 9 is used instead of the second polarizer 4 in the construction shown in FIG. 13. The reflection-polarizing plate 9 has a function for reflecting a polarized light component in a specific direction and for transmitting the remaining polarized light components. A direction of a reflection axis of the reflection-polarizing plate 9 is set in the same direction as the polarization direction of either a component (light) which is converted with its polarization direction by the liquid crystal layer to be emitted from the liquid crystal panel 1 or a component which is emitted from the liquid crystal panel 1, without being converted with its polarization direction by the liquid crystal layer of the light which has passed through the first polarizer 2 to be made incident to the liquid crystal panel 1. According to such a construction, a displayed image can be observed from the second visual point 12 as well as from the first visual point 11 with only the light incident from the first polarizer 2 side to the liquid crystal panel 1. That is, the double side display becomes possible with one sheet of liquid crystal panel 1. In particular, when the first visual point 11 is located in a position of regular reflection with respect to an incident angle of the incident light, the brightest image display can be observed from the first visual point 11. On the other hand, when the second visual point 12 is located on a straight line with respect to the incident angle of the incident light, the brightest image display can be observed from the second visual point. When the reflection-polarizing plate 9 is used instead of the second polarizer 4 shown in FIG. 13, no partial reflector needs to be formed inside the liquid crystal panel 1.

Moreover, the light is prevented from being made incident from the second visual point 12 side to a dark area (an area where there is no light emitted from the reflection polarizer 9 to the second visual point 12 side) of the liquid crystal panel 1, thereby enhancing the visibility from the second visual point 12 side. For example, as shown in FIG. 16, a second polarizer 4 which has an absorption axis in the same direction as that of the reflection axis of the reflection-polarizing plate 9 is disposed outside the reflection-polarizing plate 9, thereby resulting in no light being reflected to the second visual point 12 side in the dark area of the reflection-polarizing plate 9. As a result, the visibility from the second visual point 12 side is enhanced.

A (2n−1)/4 wave plate in the double side visible type liquid crystal display device of the present invention adopting the reflection-polarizing plate 9 as shown in FIGS. 15 and 16 has the same operation as that of the (2n−1)/4 wave plate 7 described with reference to FIG. 13, so its description is omitted here for the sake of simplicity.

(Embodiment 7)

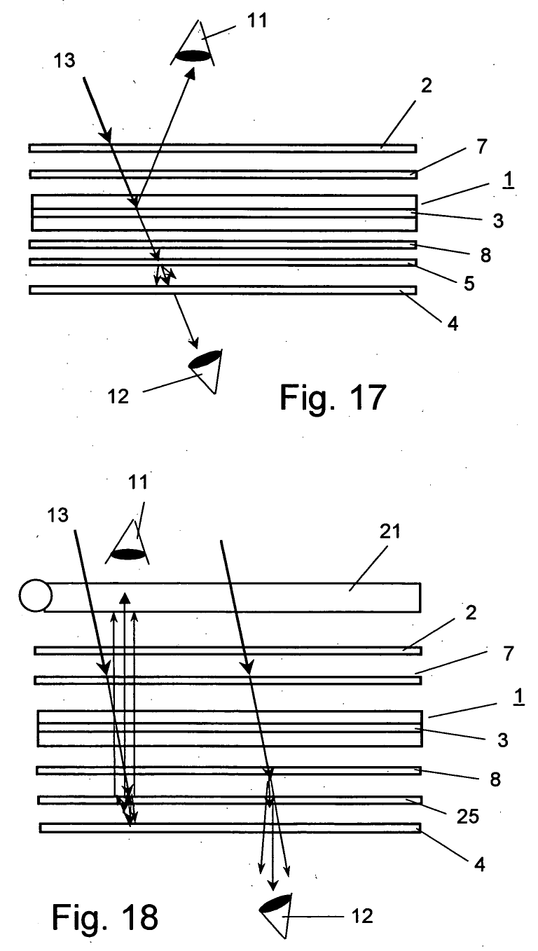

A construction of a liquid crystal display device according to Embodiment 7 is schematically shown in FIG. 17. In Embodiment 7, a diffusion layer 5 is disposed between the (2m−1)/4 wave plate 8 and the second polarizer 4 included in the construction of Embodiment 5 shown in FIG. 13. Here, the diffusion layer 5 has a function for scattering the light in a specific range, when the light passes: through the diffusion layer 5. Thus, the disposition of the diffusion layer 5 makes it possible for the light scattered by the diffusion layer 5 to pass through the second polarizer 4 to reach the second visual point 12, even when the second visual point 12 is not located on the extension of the straight line in a direction of incident light 13 with an incident angle. As a result, a range of a visual angle is widened for a second observer as well. Consequently, even when the incident angle of the incident light 13, or a position of a visual point of an observer is changed (i.e., even when a relative position between the incident light 13 with the incident angle and an observation direction of an observer is changed), there still are the reflected light components or the transmitted light components which are scattered in various directions by the diffusion layer 5. This results in that a range of a visual angle of an observer is widened.

In addition, similar to each of the constructions shown in FIGS. 2, 8 and 14, a front light type light unit disposed above the first polarizer 2, makes it possible to visually recognize a displayed image from either of the first and second visual points 11 and 12 even under the dark environment. Moreover, in the case where the reflection-polarizing plate 9 shown in FIGS. 15 and 16 is used, a diffusion layer may also be disposed outside the reflection polarizer 9, or between the reflection-polarizing plate 9 and the second polarizer 4, to obtain the same effects as those of Embodiment 6.

(Embodiment 8)

A construction of a liquid crystal display device according to Embodiment 8 is schematically shown in FIG. 18. In Embodiment 4, a directive diffusion layer 25 is disposed instead of the diffusion layer 5 of Embodiment 3 shown in FIG. 17. Similarly to Embodiments 1 to 7 described above, a description will hereinafter be given by giving as an example a case where light is made incident from a first polarizer 2 side to a liquid crystal panel 1. Note that a description overlapping that of each of Embodiments 1 to 3 is suitably omitted for the sake of simplicity. As shown in the figure, in Embodiment 8, the transmission-mirror 3 is formed in the liquid crystal panel 1, and the directive diffusion layer 25 is disposed between the (2m−1)/4 wave plate and the second polarizer 4. In addition, a front light 21 for irradiating with illuminating light to the liquid crystal panel 1 is disposed as shown in the figure. The directive diffusion layer 25 has a function for scattering the light with a specific incident angle range and for directing the scattered light in a specific direction. That is, the directive diffusion layer 25 has the property of transmitting almost all of the incident light from a thickness direction (normal line direction), of collecting effectively the diffused light which is obtained by diffusing the light with an incident angle of 5° to 15° in the thickness direction, i.e., to the front of an observer, and for transmitting almost all of the incident light with an incident angle of equal to or larger than about 20° as a critical angle. Thus, the diffused light obtained from the incident light 13 with the various incident angles can be observed from the first visual point 11 and hence the brightness is enhanced. Note that the directive diffusion layer 25 with properties shown in FIG. 9 is used here.

Here, let us consider a case where a displayed image is observed from the first visual point 11. In order to enhance the appearance of the display when a displayed image is observed with the outside light, the directive diffusion layer 25 is required to have excellent reflection characteristics. Thus, it is better to use the directive diffusion layer 25 with the characteristics such as a low transmittance and large scattering. On the other hand, in order to enhance the appearance of the display when a displayed image is observed in low light using a front light, it is better to use the directive diffusion layer with the characteristics such as a high transmittance and small scattering.

On the other hand, when a displayed image is observed from the second visual point 12, the directive diffusion layer 25 is required to have the excellent transmission characteristics. Thus, it is better to use the directive diffusion layer 25 showing the characteristics such as a high transmittance and small scattering. In addition, when the directive diffusion layer 25 having such characteristics is used, the blur in a displayed image can be prevented.

(Embodiment 9)

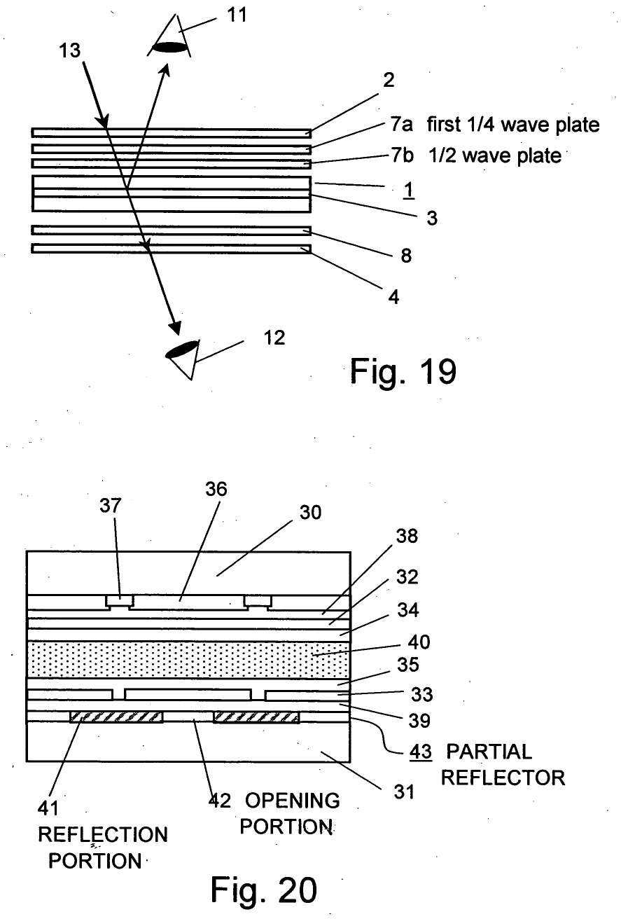

A construction of a liquid crystal display device according to Embodiment 9 is schematically shown in FIG. 19. In Embodiment 9, a first ¼ wave plate 7a and a ½ wave plate 7b which are put one on the other are disposed as the (2n−1)/4 wave plate 7 in each of the aforementioned constructions of Embodiments 5 and 6, and a second ¼ wave plate is used as the (2m−1)/4 wave plate 8. The addition of the ½ wave plate 7b makes it possible to prevent excellently the reflection in wider wavelength bands. With such a construction, the liquid crystal display device of the present invention can be readily realized using the existing ¼ wave plate and the existing ½ wave plate. Of course, a ¾ wave plate and a 5/4 wave plate may be manufactured for disposition within the liquid crystal display device. The larger the values of the natural numbers n and m become, the wider wavelength band becomes where the reflection is prevented excellently. In this case, however, the cost of the wave plates also increases, it is desirable to select the suitable values of the natural numbers n and m.

It should be noted that while in the figures explaining Embodiments 1 to 9 described above, the optical elements such as the polarizers and the transmission-mirror are shown so as to be separated from other constituent elements, the optical elements such as the polarizers and the transmission-mirror may also be joined to the other constituent elements such as the liquid crystal panel using a pressure sensitive adhesive.

Here, a description will hereinafter be given with respect to the liquid crystal panel applied to each of Embodiments 1 to 9 described above. Inside of the liquid crystal panel, the transmission-mirror for reflecting a part of the incident light and for transmitting the remaining part of the incident light is formed. As for the liquid crystal panel having the transmission-mirror formed therein, there are such constructions as adopting a partial reflector serving as a reflecting mirror having an opening partially formed in a pixel area as the transmission-mirror, or adopting a transflective layer having a predetermined rate of light transmittance as the transmission-mirror as shown in FIGS. 4 to 6. Hereinafter, a specific description will be given with respect to the construction adopting the partial reflector having an opening partially formed in a pixel area as the transmission-mirror.

FIG. 20 is a cross sectional view schematically showing a construction adopting a partial reflector 43 as the transmission-mirror within a simple matrix type color liquid crystal panel. A first transparent electrode 32 is formed on a transparent substrate 30 through a flattening layer 38. On the transparent substrate, a color filter 36 and a light shielding layer 37 are formed. Also, a partial reflector 43 is formed on a second transparent substrate 31 and a second transparent electrode 33 is formed thereon through an insulating film 39. The first and second electrodes are disposed so as to be orthogonal to each other. Pixels are defined at intersection portions between the first and second transparent electrodes. The partial reflector 43 has a reflecting portion 41 and an opening portion 42 disposed on a position corresponding to its pixel portion. Then, a first orientation film 34 is formed so as to cover lower surfaces of the transparent electrodes 32 and a second orientation film 35 is formed so as to cover upper surfaces of the counter electrodes 33. The first and second orientation films 34 and 35 regulate a direction of orientation of the liquid crystal molecules of the liquid crystal layer 40 held between the first and second orientation films 34 and 35. A description will be made with respect to the display principle in the case where the liquid crystal panel with such a construction is adopted in the display device with the construction shown in FIG. 3. The light incident from the first polarizer 2 side is successively transmitted through the transparent substrate 30, the color filter 36, the flattening layer 38, the first transparent electrodes 32, the first orientation film 34, the liquid crystal layer 40, the second orientation film 35, the second transparent electrode 33, and the insulating film 39 to reach the partial reflector 43. A part of the light arriving at the partial reflector 43 is reflected by the reflection portion 41 to be returned back to the first polarized 2 again, while the remaining part thereof is transmitted through the opening portion 42 to reach the second polarizer 4. As a result, a color image can be observed from both the first and second visual points.

In FIG. 20, even when the partial reflector 3 is made of Al or Ag, or a metallic compound containing Al and Ag as the basic constituent, the partial reflector 3 has only to be formed into the form of a thin film without the fine patterning thereof because the partial reflector 3 is electrically separated from the second transparent electrode 33 through the insulating film 35. In addition, when the partial reflector 3 is made of an insulator such as a dielectric multi-layer film, the insulating film 35 can be omitted.

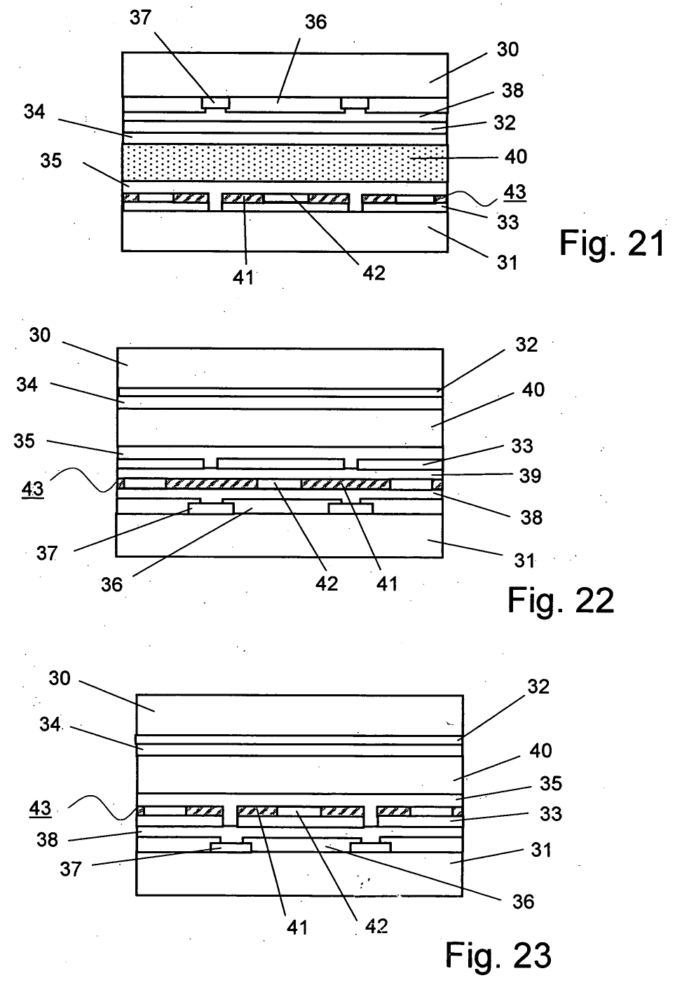

FIG. 21 is a cross sectional view schematically showing a construction of Embodiment of a simple matrix type color liquid crystal panel adopting a partial reflector 43 as the transmission-mirror. This construction is different from that shown in FIG. 20 in that the partial reflector 43 is directly formed on an upper surface of a second transparent electrode 33. Then, the partial reflector 43 is formed through the fine patterning process so as to correspond in shape to the second transparent electrode 33. At this time, when the partial reflector 43 is made of Al or Ag or a metallic compound containing Al and Ag as the basic constituent, the partial reflector 43 has an operation not only to reflect and transmit the light, but also to increase an electric conductivity of the second transparent electrode 33 to reduce the power consumption. Note that, in Embodiment shown in FIG. 21, although the description has been given with respect to the case where the partial reflector 43 is formed on the upper surface of the second transparent electrode 33, the partial reflector 43 may also be formed on a lower surface of the second transparent electrode 33. Of course, when the partial reflector 43 is formed of a dielectric multi-layer film, it is unnecessary to form the partial reflector 43 through the fine patterning so as to correspond in shape to the second transparent electrode 33. With this construction, similar to the construction shown in FIG. 20, an excellent color image can also be observed from either of the first and second visual points.

FIG. 22 is a cross sectional view schematically showing a construction of Embodiment of a simple matrix type color liquid crystal panel adopting a partial reflector 43 as the transmission-mirror. As shown in the figure, the partial reflector 43 is formed between a color filter 36 and a second transparent electrode 33. In the case of this construction, a flattening layer 38 may be omitted. In addition, when the partial reflector 43 is made of an insulator such as a dielectric multi-layer film, an insulating film 39 may be omitted. In a case where the liquid crystal panel having this construction is used in the liquid crystal display device of Embodiment 2 shown in FIG. 3, when a displayed image is observed from the second visual point with the illuminating light from the first polarizer 2 as the transmitted light, a color image can be obtained by being observed with the illuminating light from the second polarizer 4 as the transmitted light, and a monochrome image can be obtained by observing the reflected light of the light incident from the first polarizer 2 side. The monochrome image obtained at this time can perform display a bright image even with the natural light because the image is obtained without through the color filter 36 in the middle of an optical path. Thus, this is very effective in reducing the power consumption. However, there is also a case where no image is obtained, depending on the reflected light of the light incident from the second polarizer 4 side. Accordingly, the front light type light unit is preferably disposed on the first polarizer 2 side.

FIG. 23 is a cross sectional view schematically showing a construction of Embodiment of a simple matrix type color liquid crystal panel adopting a partial reflector 43 as the transmission-mirror. The construction shown in FIG. 23 is different from that shown in FIG. 22 in that the partial reflector 43 is directly formed on an upper surface of a second transparent electrode 33. When the partial reflector 43 is made of Al or Ag, or a metallic compound containing Al and Ag as the basic constituent, the partial reflector 43 has an operation not only to reflect and transmit the light, but also to increase an electric conductivity of the second transparent electrode 33 to reduce the power consumption. Note that, in Embodiment shown in FIG. 23, although the description has been given with respect to the case where the partial reflector 43 is formed on the upper surface of the second transparent electrode 33, the partial reflector 43 may also be formed on a lower surface of the second transparent electrode 33.

In addition, in each of the constructions of Embodiments shown in FIGS. 20 to 23, the opening portion 42 formed in the partial reflector 43 is located at a central portion of the second transparent electrode 33. However, the opening portion 42 may be located at an arbitrary portion of the second transparent electrode 33, and a plurality of openings may correspond to one pixel as long as an objective opening rate is obtained for the pixel portion.

While in each of Embodiments shown in FIGS. 20 to 23, the description has been given with respect to the simple matrix type liquid crystal display device, it is to be understood that the same effects can also be obtained in an active matrix type liquid crystal display device in which thin film transistors and thin film diodes are disposed in each of the pixels. Note that, in FIGS. 20 to 23 explaining Embodiments, although the optical elements such as the polarizers and the scattering plate are expressed so as to be separated from other constituent elements, the optical elements such as the polarizers and the scattering plate may also be joined by a pressure sensitive adhesive to other constituent elements such as the liquid crystal panel. Concrete Examples of the present invention will hereinafter be described in more detail.

### CONCRETE EXAMPLE 6

The liquid crystal display device of Embodiment 9 shown in FIG. 19 was manufactured adopting the liquid crystal panel having the partial reflector 43 therein as shown in FIG. 20. After a metallic compound containing Ag and Pd was formed into a thickness of 800 to 2,000 \acute{Å} by utilizing a vacuum evaporation method, the opening portion 42 having an opening rate of 20 to 70% was formed in the central portion of the pixel portion through the photolithography process to obtain the partial reflector 43. Then, instead of the (2n−1)/4 wave plate 7, one sheet of ¼ wave plate 7a and one sheet of ½ wave plate 7b were inserted successively from the side of the first polarizer 2. Moreover, one sheet of ¼ wave plate was inserted as the (2m−1)/4 wave plate 8. Also, the front light type light unit was disposed on the first polarizer 2 side. As a result, an excellent image free from the reflection could be obtained from both of the first visual point 11 and the second visual point 12. When the opening rate of the partial reflector 43 was so high as to fall within a range of 50 to 70%, an image with the transmitted light was observed brighter from the second visual point 12, while when the opening rate of the partial reflector 43 was so low as to fall within a range of 20 to 30%, an image with the reflected light was observed brighter from the first visual point 12.

### CONCRETE EXAMPLE 7

The liquid crystal display device of Embodiment 9 shown in FIG. 13 was manufactured adopting the liquid crystal panel having the partial reflector 43 therein as shown in FIG. 20. After a λ/4 films each containing silicon dioxide and titanium oxide were laminated alternately by utilizing a vacuum evaporation method to be formed into a dielectric multi-layer film having an reflection rate of 80 to 98%, a partial reflector 43 having an opening rate of 20 to 80% was formed through the photolithography process. Then, one sheet of ¾ wave plate was inserted as the (2n−1)/4 wave plate 7. Moreover, one sheet of ¼ wave plate was inserted as the (2m−1)/4 wave plate 8. Also, the front light type light unit was disposed on the first polarizer 2 side. As a result, similar to Concrete Example 6, an excellent color image free from the reflection could be obtained from both of the first visual point 11 from the second visual point 12. When compared to the case of Concrete Example 6 where a metallic thin film was used as a partial reflector, brightness of the image both by reflection and by transmission was similarly improved

### CONCRETE EXAMPLE 8

The liquid crystal display device of Embodiment 6 shown in FIG. 15 was manufactured adopting the conventional translucent type TFT liquid crystal panel. One sheet of ¼ wave plate 7a and one sheet of ½ wave plate 7b were inserted successively as the (2n−1)/4 wave plate 7 from the side of the first polarizer 2. Moreover, one sheet of ¼ wave plate was inserted as the (2m−1)/4 wave plate 8. Also, the reflection-polarizing plate is disposed outside of the (2m−1)/4 wave plate (the second visual side) and the front light type light unit was disposed on the first polarizer 2 side. As a result, an excellent color image free from the reflection could be obtained from both of the first visual point 11 and the second visual point 12.

### CONCRETE EXAMPLE 9

In the double side visible type liquid crystal display device manufactured in Concrete Example 6, a diffusion layer was inserted into a position shown in FIG. 17. As the diffusion layer 5, a PET on which acrylate beads having an average particle diameter of 10 μm were applied to obtain a diffusion plate having a haze value of 70% was used. As a result, an angle of visual field from the second visual point could be remarkably widened in the double side visible type liquid crystal display device manufactured in Concrete Example 6.

### CONCRETE EXAMPLE 10

The double side visible type liquid crystal display device of Embodiment 9 shown in FIG. 19 was manufactured adopting the liquid crystal panel having the partial reflector 43 therein as shown in FIG. 21. After a metallic compound containing Ag and Pd was formed into a thickness of 800 to 2,000 \acute{Å} through the sputtering process, the partial reflector 43 having an opening rate of 20 to 70% was formed. Then, instead of the (2n−1)/4 wave plate 7, one sheet of ¼ wave plate 7a and one sheet of ½ wave plate 7b were inserted successively from the side of the first polarizer 2a. Moreover, one sheet of ¼ wave plate was inserted as the (2m−1)/4 wave plate 8. Also, the front light type light unit was disposed on the first polarizer 2 side. As a result, an excellent color image free from the reflection could be obtained from both of the first visual point 11 and the second visual point 12. Also, with such a construction, an impedance of the liquid crystal driving electrodes could be reduced to a value which is substantially equal to a value as in the case where each driving electrode is made of a metal material, and hence it also becomes possible to obtain an excellent image free from the tailing.

### CONCRETE EXAMPLE 11

The double side visible type liquid crystal display device shown in FIG. 19 was manufactured adopting the liquid crystal panel having the partial reflector 43 therein as shown in FIG. 23. A metallic compound containing Ag and Pd was formed into a thickness of 800 to 2,000 \acute{Å} through the sputtering process to be used as the partial reflector 43 having an opening rate of 20 to 70%. One sheet of ¼ wave plate 7a and one sheet of ½ wave plate 7b instead of the (2n−1)/4 wave plate 7 were inserted successively from the side of the first polarizer 2. Moreover, as the (2m−1)/4 wave plate 8, one sheet of ¼ wave plate and one sheet of ½ wave plate were inserted. Also, the front light type light unit was disposed on the first polarizer 2 side. As a result, an excellent monochrome image could be observed from the front visual point 11, while an excellent color image free from the reflection could be observed from the second visual point 12. In particular, a monochrome image from the first visual point 11 could be observed as a bright image even with the natural light because-there was no such medium as a color filter for absorbing the light existed in the optical path. Also, with such a construction, an impedance of the liquid crystal driving electrodes could be reduced to a value which is substantially equal to a value as in the case where each driving electrode is made of a metal material, and hence it also becomes possible to obtain an excellent image free from the tailing.

1. A liquid crystal display device, comprising:
a liquid crystal panel having a liquid crystal layer held between substrates;
a first polarizer and a second polarizer disposed such that the liquid crystal panel is held therebetween; and
a transflector provided between the liquid crystal layer and the second polarizer, the transflector having a function for reflecting incident light at a predetermined rate and for transmitting the remaining light,
wherein the light reflected by the transflector can be observed on a side of the first polarizer, and the light transmitted through the transflector can be observed on a side of the second polarizer.

2. A liquid crystal display device according to claim 1, wherein the transflector is a transmission-mirror for reflecting the incident light at a predetermined rate irrespective of polarized light components and for transmitting the light other than the reflected light.

3. A liquid crystal display device according to claim 1, further comprising:
a first optical compensator provided between the first polarizer and the liquid crystal layer; and
a second optical compensator provided between the second polarizer and the transflector.

4. A liquid crystal display device according to claim 3, wherein a reflection-polarizing plate for reflecting a polarized light component in a specific direction and for transmitting the remaining polarized light components is provided outside the second optical compensator instead of the transflector and the second polarizer.

5. A liquid crystal display device according to claim 4, wherein a direction of a reflection axis of the reflection-polarizing plate is set in the same direction as either of a polarization direction of light which is converted with its polarization direction by the liquid crystal layer and emitted from the liquid crystal panel, or a polarization direction of light which is emitted from the liquid crystal panel without being converted with its polarization direction by the liquid crystal layer.

6. A liquid crystal display device according to claim 5, further comprising a second polarizer having an absorption axis in the same direction as that of the reflection axis of the reflection-polarizing plate, the second polarizer being provided outside the reflection-polarizing plate.

7. A liquid crystal display device according to claim 3, wherein the first optical compensator has characteristics for optically compensating for the second optical compensator.

8. A liquid crystal display device according to claim 7, wherein the first optical compensator is a retardation plate that has characteristics for optically compensating for the second optical compensator and for compensating for modulation by the liquid crystal layer.

9. A liquid crystal display device according to claim 3, wherein the first optical compensator includes a (2n−1)/4 wave plate (n: natural number), and the second optical compensator includes a (2m−1)/4 wave plate (m: natural number).

10. A liquid crystal display device according to claim 9, wherein the first optical compensator includes a ½ wave plate.

11. A liquid crystal display device according to claim 9, wherein each of the (2n−1)/4 wave plate and the (2m−1)/4 wave plate is a ¼ wave plate.

12. A liquid crystal display device according to claim 1, wherein the transflector is formed inside the liquid crystal panel.

13. A liquid crystal display device according to claim 12, wherein the liquid crystal panel has a transparent substrate and a counter substrate between which the liquid crystal is held, the first polarizer is provided outside the transparent substrate side, the second polarizer is provided outside the counter substrate, the transflector is provided on the counter substrate, and a counter electrode is formed on the transflector through an insulating film.

14. A liquid crystal display device according to claim 12, wherein the liquid crystal panel has a transparent substrate having a transparent electrode for driving formed thereon and a counter substrate having a counter electrode for driving formed thereon, the liquid crystal layer being held between the transparent substrate and the counter substrate, the first polarizer is provided outside the transparent substrate side, the second polarizer is provided outside the counter electrode side, and the transflector is provided on an upper surface or a lower surface of the counter electrode such that electrical independence of the counter electrode is maintained.

15. A liquid crystal display device according to claim 1, wherein the transflector is a dielectric multi-layer film having a predetermined transmittance.

16. A liquid crystal display device according to claim 1, wherein the transflector is a metallic film layer having a predetermined transmittance.

17. A liquid crystal display device according to claim 1, wherein the transflector has an opening portion in a position corresponding to a pixel portion of the liquid crystal panel.

18. A liquid crystal display device according to claim 1, further comprising:
a driving circuit for converting a signal to be applied to the liquid crystal panel to supply the resultant signal to the liquid crystal panel depending on whether the liquid crystal panel is observed from the first polarizer side or a side opposite to the first polarizer side.

19. A liquid crystal display device according to claim 1, further comprising a front light type light unit provided outside the first polarizer, for irradiating with light from the first polarizer side to the liquid crystal panel.
